(19) United States
(12) Patent Application Publication
(10) Pub. No.: US 2006/0098094 A1
(43) Pub. Date: May 11, 2006

(54) Portable wireless rearview camera system for a vehicle

(76) Inventor: Madison J. Lott, Petaluma, CA (US)

Correspondence Address: Turning Point Law, Suite 116, 100 Smith Ranch Road, San Rafael, CA, 94903, US

(21) Appl. No.: 10/983,846

(22) Filed: Nov. 8, 2004

(51) Int. Cl. H04N 7/18; H04N 9/47

(52) U.S. Cl. 348/148

(57) ABSTRACT

A portable wireless rearview camera system for vehicles is provide that is comprised of a movable weather resistant camera housing unit that wirelessly transmits images to the movable display unit. The weather resistant camera housing unit comprises a video camera to capture images behind the vehicle and a wireless transmitter to transmit the images to the movable display unit. The camera housing unit is connected to the vehicle or its attached trailer by a shielded magnet, which can easily be removed for use on another vehicle or to prevent its theft. The movable display unit comprises a wireless receiver coupled with a video monitor to display the images transmitted from the rear view camera to provide the vehicle's driver with a real time image of what is behind the vehicle.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of the Invention

The invention herein relates to a portable camera system connected to a vehicle that using wireless radio transmission, transmits rearview images from the vehicle to a portable battery operated display device positioned to be visible to the driver.

### BACKGROUND OF THE INVENTION

The rearview mirrors at the left and right side of a vehicle are usually utilized to assist the drive while reversing a vehicle. The dangers associated with backing up a motorized vehicle are largely the result of the driver's inability to see whatever is in the area directly behind the vehicle. The field of vision of the rearview mirrors is limited and due to the numerous blind angles present, vehicle reversal based on such a limited field of vision can be quite difficult or dangerous. The larger the vehicle, the larger the blind spot, and the more likely accidental damage may occur. Furthermore, a vehicle can be connected to a camping trailer, boat trailer, or such other type of trailer, which enlarges the blind spot. Even if with skill and caution, the driver can cause property damage and even injury or death to others as a result from not being able to see what lies immediately behind the vehicle.

The blind spot behind the vehicle also makes it difficult for a driver to judge the distance from the back of the vehicle to another vehicle, a trailer, or an obstacle. The process of coupling a trailer to a bumper, fifth wheel or gooseneck hitch is a tedious process which often requires the assistance of a second party. If a second party is not available, the driver may have to leave the vehicle, view the progress, and reenter the vehicle in the attempt to couple the trailer and the vehicle at the hitch. This process can be time consuming and frustrating. Moving a large vehicle, with or without a trailer, is also difficult without an accurate view of exactly how close the back of a driver's vehicle or trailer is to any object that may be to the rear.

Several solutions have been developed to address these problems. Some cars are outfitted with additional mirrors, but on many vehicles it is difficult to attach enough mirrors to allow the driver to see everything behind the vehicle. Using a system with several mirrors can also be problematic because mirrors often provide a skewed image and a distorted perspective.

Other solutions provide a camera that attaches to the back of the vehicle. The camera sends video data to a monitor in the cab of the vehicle so the driver can see the area behind the vehicle that the camera is monitoring. The first generation of these rear-view camera devices were hard-wired installations, requiring wires to be concealed in the vehicle interior. When a wired-type rear-view camera device is utilized on a trailer attached to a vehicle, every vehicle separation from or connection with the trailer requires the reinstallation of wiring, or at best, the connection of the camera and monitor wiring, causing greater difficulty in the practical use of the device.

Cameras can also be affixed to vehicles near a hitch to help a driver couple the hitch to a trailer. However, in this configuration the image from the camera can be difficult to interpret because the image only offers an orthogonal of an area behind the vehicle. The rearview camera system allows the driver to view directly behind the vehicle in the blind spot area, said areas which are not viewable with the standard mirror systems and other means provided by the vehicle manufacturer.

Prior art rearview camera systems have several drawbacks. Certain rearview cameras are mechanically fastened under or near the rear bumper, on the inside or outside or the rear window, or by drilling holes in the motor vehicle rear door or by attaching custom bracketry and/or holders which are different which each vehicle type, and by attachment, are not easily movable. These types of installation often require skilled labor, special tools, and the necessity of dismantling interior panels, and may compromise the structure's mechanical strength. Such systems often comprise the interior and exterior appearance or viewability of the rear parts of the motor vehicle, and are often made inoperable by simple vandalism, very minor accidents, and common environmental factors.

Recently several auto manufacturers have included or will include built in rear view camera systems for selected new models. These systems will work only on these particular models, and cannot be retrofitted to other vehicles, and are often being viewable with the navigation system screen. Other manufacturers for displays are using the half silvered rearview mirror with LCD TV viewers, which are hardwired to the rearview camera.

No rearview camera system in the prior art is entirely portable and can be used on multiple vehicles without requiring some modification to the vehicle or the camera system. No rearview camera system in the prior art can be attached to a vehicle without the need for custom brackets or parts, labor for installation, routing cables through the vehicle, or mounting on the trailer hitch when the hitch is not in use. No prior art rearview camera system is entirely wireless where the same display device can receive images from a camera unit attached to the rear of the vehicle when the vehicle has no trailer, or the same camera unit attached to the rear of the trailer when a trailer is in use.

### SUMMARY

Accordingly, the general purpose of the invention is to provide a removably attached wireless rearview camera system for a vehicle that transmits review images to a display device visible to the driver to aid in the operation of a vehicle in the reverse direction, comprising a movable weather resistant camera housing unit comprised of a camera, a wireless transmitter, an external power source and means to attach the unit to the exterior of the vehicle or an attached trailer, and a separate movable display unit comprising a display device, a wireless receiver coupled to the wireless transmitter of the camera housing unit, a power source, and an attachment means, thereby eliminating the need for a wired installation.

A further objective of the invention is to provide a device of the kind indicated to be entirely portable where the camera housing unit can be easily attached or removed from the rear of the vehicle or the rear of an attached trailer by means of a shielded magnet.

Another object of the invention is to provide a device of the kind indicated to be portable where the display unit can be attached to, and viewed by the driver in, a location inside the vehicle of the driver's choice.

Another object of the invention is to provide a device of the kind indicated where the images captured by the camera are wirelessly transmitted to the display device thereby eliminating a wired connection.

A further objective of the invention is to provide an improved device of the kind indicated where the camera system can easily, be moved from one vehicle to another, or removed from the vehicle for safekeeping and storage until its use is needed again.

### DRAWINGS—FIGURE

Various objects, features and advantages of the present invention will become fully appreciated and better understood when considered in conjunction with the accompanying drawings shows one embodiment of the invention, with reference characters designating the same parts throughout the view:

FIG. 1 is a block diagram of the camera housing unit and the movable display unit.

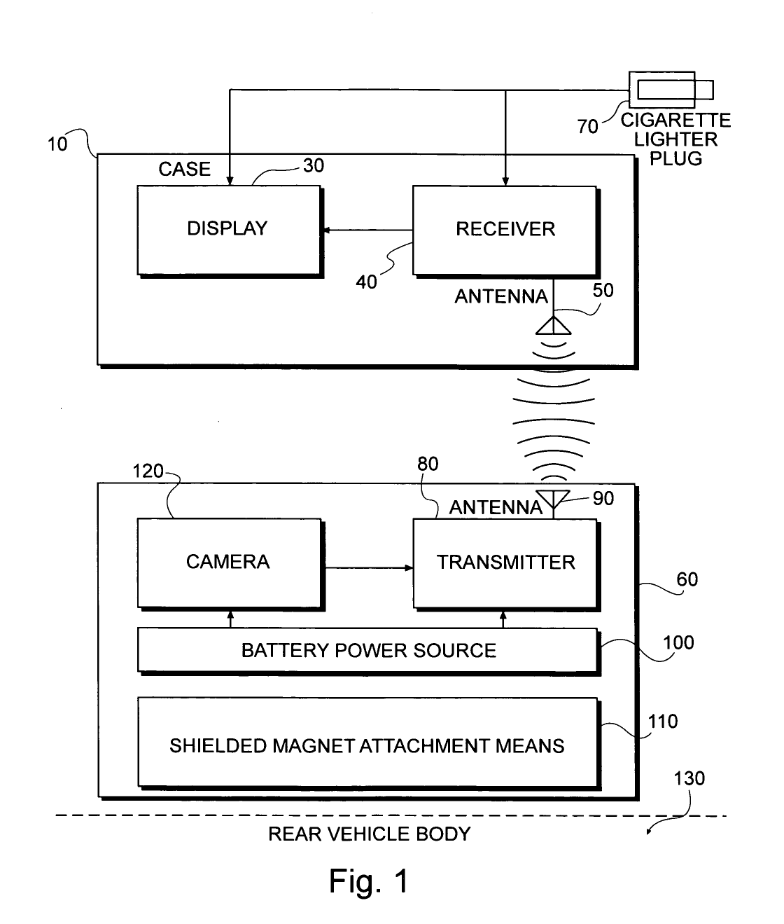

### DRAWINGS—Reference Numerals

10. Movable Display Unit
30. Display Device
40. Wireless Receiver
50. Receiver Antenna
60. Camera Housing Unit
70. Cigarette Lighter Plug
80. Wireless Transmitter
90. Transmitter Antenna
100. Battery Power Source
110. Shielded Magnet
120. Miniature Camera
130. Rear of Vehicle

### DETAILED DESCRIPTION OF THE INVENTION

The system in accordance with the invention is used for wirelessly transmitting video images from the rear of a vehicle to the driver in the interior of the vehicle. This preferred embodiment of the system includes:
a movable weather resistant camera housing unit 60 comprising a miniature camera 120, a wireless transmitter 80, a power source 100 and an external attachment means 110, and
a movable display case 10 located apart therefrom comprising a display device 30, a wireless receiver 40 coupled to the wireless transmitter 80 of the camera housing unit 60, and a power source 70.

The miniature camera 120 is a standard component available off the shelf. A standard video signal is input into the wireless transmitter 80 from the miniature camera 120, which together with the antenna 90, are standard off the shelf components. In some instances, the miniature camera 120, the wireless transmitter 80, and the transmitter antenna 90, can be purchased together as a standard off the shelf unit. The camera housing unit 60 contains a power source 100, which the preferred embodiment is a battery, and an attachment means 110, which the preferred embodiment is a shielded magnet of sufficient strength to attach the camera housing unit 60 to the body, bumper, or other such surface, that is the rear of the vehicle 130 in a manner where the miniature camera 120 is pointed in the read direction from the vehicle.

The wireless receiver 40 in the display case 10 is a standard off the shelf component which receives through the receiver antenna 50 a standard radio transmission signals from, and of the same frequency and type produced by the wireless transmitter 80 and delivered through the transmitter antenna 90. The wireless receiver 40 produces a standard video signal from which the display device 30 produces the image captured by the miniature camera 120. The display device 30 may be a color or black and white LCD screen, or such other display device of a similar nature. The display device 30 and wireless receive 40 are powered by the vehicles 12 volt battery as delivered through the cigarette lighter plug 70 connected to the vehicles cigarette lighter socket in the vehicle's interior.

What is claimed is:

1. A removably attached wireless rearview camera system for a vehicle that transmits review images to a display device visible to the driver comprising:
A movable weather resistant camera housing unit comprising a miniature camera, a wireless transmitter, a power source and an external attachment means, and
A movable display case located apart therefrom comprising a display device, a wireless receiver coupled to the wireless transmitter of the camera housing unit, and a power source.

2. The removably attached wireless rearview camera system of claim 1 wherein the power source is a battery for independent battery-powered operation.

3. The removably attached wireless rearview camera system of claim 1 wherein the external power source is connected to said camera housing unit through a power cord which receives power from the vehicle trailer hitch.

4. The removably attached wireless rearview camera system of claim 1 wherein the external attachment means is a shielded magnet to magnetically and removably mount the camera housing unit to the rear of the vehicle, and shielded to minimize interference with the wireless transmitter signal.
